(19) United States
(12) Patent Application Publication
(10) Pub. No.: US 2026/0215407 A1
(43) Pub. Date: Jul. 30, 2026

(54) FISHING ROD REEL SEAT, AND FISHING ROD

(71) Applicant: GLOBERIDE, Inc., Tokyo (JP)

(72) Inventor: Toshiki MORIOKA, Higashikurume-shi (JP)

(73) Assignee: GLOBERIDE, Inc., Tokyo (JP)

(21) Appl. No.: 19/359,162

(22) Filed: Oct. 15, 2025

(30) Foreign Application Priority Data
Jan. 30, 2025 (JP) 2025-014074

(51) Int. Cl. A01K 87/06

(52) U.S. Cl. CPC A01K 87/06

(57) ABSTRACT

A fishing rod reel seat according to one embodiment of the present invention is a fishing rod reel seat comprising: a reel seat main body in which a reel leg placing portion and a fixed hood are formed; and a moving hood, in which the moving hood comprises: a hood portion; and a finger placement portion, and a maximum length of the finger placement portion in the axial direction of the reel seat main body from the first end to the second end at a position of a side surface portion of the finger placement portion is larger than a length of the finger placement portion in the axial direction of the reel seat main body from the first end to the second end at a position of a bottom surface portion of the finger placement portion.

### CROSS-REFERENCE TO RELATED APPLICATION

This application claims priority under 35 U.S.C. § 119 to Japanese Patent Application No. 2025-014074 filed on January 30, 2025 in the Japanese Patent Office, the entire contents of each hereby incorporated by reference.

### BACKGROUND OF THE INVENTION

### 1. TECHNICAL FIELD

The present invention relates to a fishing rod reel seat, and a fishing rod comprising the fishing rod reel seat.

### 2. DESCRIPTION OF THE RELATED ART

In the related art, various devices for fixing a fishing rod attachment leg of a fishing reel to a fishing rod are known. For example, such a reel fixing device includes a reel seat main body provided with a placement portion on which a fishing rod attachment leg of a fishing reel is placed. A fixed hood for fixing one end of the fishing rod attachment leg is provided at one end of the reel seat main body. A moving hood is attached to the other end of the reel seat main body so as to be movable facing the fixed hood.

JP 7546979 B2 discloses a reel seat that couples a reel having first and second legs to a rod body of a fishing rod, the reel seat including: a seat body having a bore formed in an axial direction of the rod body and connectable to the rod body; and a movable hood movably coupled to the seat body along a central axis of the bore, in which the seat body includes: an attachable portion that forms a part of an upper surface of the seat body or a part of a lower surface of the seat body and attaches the first and second legs; a first hood portion that is positioned at the attachable portion so as to face the movable hood and fixes the first leg; and a protruding portion that is formed along a circumferential direction of the central axis on an opposite side of the attachable portion with respect to the central axis and protrudes in an outer radial direction of the central axis, a cylindrical end extending along the central axis from the attachable portion and the protruding portion, a male screw formed on an outer periphery of the cylindrical end, and a pair of guide grooves extending to the protruding portion from one end of the cylindrical end through the male screw. The movable hood includes a nut rotatably coupled to the male screw of the seat body in the circumferential direction, and a movable body movable along the central axis by the nut, the movable body includes: an annular portion to which the nut is relatively rotatably coupled; a second hood portion extending from the annular portion toward the first hood portion, the second hood portion being formed to press and fix the second leg to the attachable portion, the second hood portion being located on an opposite side of the protruding portion in a vertical direction while crossing the protruding portion along the central axis; a housing portion located on an opposite side of the second hood portion in the vertical direction, the housing portion being formed as a space between the annular portion and the second hood portion, and housing the protruding portion; a guide protrusion formed on each of a pair of side end edges of the second hood portion in the circumferential direction and slidably inserted into each of the pair of guide grooves; and a reinforcing cover configured to cover an outer surface of the second hood portion and be engaged with the pair of side end edges to prevent deformation of the second hood portion and the guide protrusion.

In addition, JP 5773622 B2 discloses a cylindrical reel seat including: a cylindrical seat main body having a leg placement surface on which a leg portion of a reel is placed; a fixed hood portion provided immovably on the seat main body; a movable hood body provided to face the fixed hood portion and having a movable hood portion for pinching the leg portion of the reel together with the fixed hood portion; and means for pressing the movable hood body toward the fixed hood portion and holding the movable hood body at the position, in which the movable hood body has a leg support surface capable of supporting a back surface of the leg portion of the reel, the leg placement surface of the seat main body is formed up to the vicinity of the movable hood portion, and an axial end of the leg placement surface located in the vicinity of the movable hood portion and the leg support surface of the movable hood body are flush with each other at least at a location where the back surface of the leg portion of the reel abuts.

### SUMMARY OF THE INVENTION

However, in the reel seat disclosed in JP 7546979 B2, there is a problem that a gripping fingertip easily comes into contact with a step difference or a gap in the axial direction on the side surface of the moving hood, and the gripping property is deteriorated. In addition, in the reel seat disclosed in JP 5773622 B2, since the gripping fingertip comes into contact with a portion extending toward the fixed hood from the moving hood, the gripping property of the fingertip can be good, but since a step difference or a gap of the moving hood comes into contact with the thumb attached to the reel seat, there is a problem that the gripping property is deteriorated.

The present invention has been made in view of the above circumstances, and an object of the present invention is to provide a fishing rod reel seat in which the gripping fingertip is prevented from coming into contact with the step difference between the moving hood and the reel seat main body and the gripping properties are improved when the reel seat is gripped, and a fishing rod comprising the fishing rod reel seat. Other objects of the present invention will become apparent upon reference to the entirety of the present specification.

A fishing rod reel seat according to one embodiment of the present invention is a fishing rod reel seat comprising: a reel seat main body in which a reel leg placing portion on which a reel leg is placed and a fixed hood into which one end of the reel leg is inserted are formed; and a moving hood guided to an outer surface of the reel seat main body and configured to be movable along an axial direction of the reel seat main body, in which the moving hood comprises: a hood portion into which the other end of the reel leg is inserted; and a finger placement portion extending from a first end to a second end of the moving hood as viewed in the axial direction of the reel seat main body, and a maximum length (L2) of the finger placement portion in the axial direction of the reel seat main body from the first end to the second end at a position of a side surface portion of the finger placement portion as viewed in a circumferential direction of the reel seat main body is larger than a length (L1) of the finger placement portion in the axial direction of the reel seat main body from the first end to the second end at a position of a bottom surface portion of the finger placement portion as viewed in the circumferential direction of the reel seat main body.

The fishing rod reel seat according to one embodiment of the present invention, in which a first edge portion formed at an end of the finger placement portion as viewed in the circumferential direction of the reel seat main body is formed on an upper surface portion side opposite to the bottom surface portion with the axial direction of the reel seat main body as a reference line as viewed in a direction from the bottom surface portion to an upper surface portion of the finger placement portion as viewed in the circumferential direction of the reel seat main body.

The fishing rod reel seat according to one embodiment of the present invention, in which a maximum length (L2) of the finger placement portion in the axial direction of the reel seat main body from the first end to the second end at a position of a side surface portion of the finger placement portion as viewed in the circumferential direction of the reel seat main body is larger by 5 mm or more than a length (L1) of the finger placement portion in the axial direction of the reel seat main body from the first end to the second end at a position of the bottom surface portion of the finger placement portion as viewed in the circumferential direction of the reel seat main body.

The fishing rod reel seat according to one embodiment of the present invention, in which the length (L1) of the finger placement portion in the axial direction of the reel seat main body from the first end to the second end at a position of the bottom surface portion of the finger placement portion as viewed in the circumferential direction of the reel seat main body is larger than a maximum length of the hood portion in the axial direction of the reel seat main body.

The fishing rod reel seat according to one embodiment of the present invention, in which a second edge portion formed at the second end of the finger placement portion as viewed in the axial direction of the reel seat main body extends from the bottom surface portion of the finger placement portion as viewed in the circumferential direction of the reel seat main body to the first edge portion in a direction of a side surface portion of the finger placement portion as viewed in the circumferential direction of the reel seat main body, and the second edge portion is formed in a concave shape in a direction of the second end from the first edge portion toward the bottom surface portion.

A fishing rod according to one embodiment of the present invention is configured to comprise any one of the fishing rod reel seats described above and a rod body.

According to the above embodiment, it is possible to provide the fishing rod reel seat in which the gripping fingertip is prevented from coming into contact with the step difference between the moving hood and the reel seat main body and the gripping properties are improved when the reel seat is gripped, and the fishing rod comprising the fishing rod reel seat.

### BRIEF DESCRIPTION OF THE DRAWINGS

FIG. 1 is a view illustrating a fishing rod according to one embodiment of the present invention;

FIG. 2 is a view illustrating a fishing rod reel seat according to one embodiment of the present invention;

FIG. 3A is a configuration diagram including a partial cross-sectional view (a cross section in a direction from the center of the bottom surface toward the center of the upper surface of the reel seat main body) of a moving hood of a reel seat according to one embodiment of the present invention, and FIG. 3B is a configuration diagram including a cross-sectional view (a cross section perpendicular to the central axis of the reel seat main body) of the moving hood of the reel seat according to one embodiment of the present invention;

FIG. 4A is a top perspective view of the reel seat according to one embodiment of the present invention, FIG. 4B is a top view of the reel seat according to one embodiment of the present invention, and FIG. 4C is a side view of the reel seat according to one embodiment of the present invention;

FIG. 5 is a view illustrating a fishing rod reel seat according to another embodiment of the present invention;

FIG. 6 is a view illustrating the fishing rod reel seat according to another embodiment of the present invention; and

FIG. 7 is a view illustrating the fishing rod reel seat according to another embodiment of the present invention.

### DETAILED DESCRIPTION

Hereinafter, an embodiment of a fishing rod according to the present invention will be specifically described with reference to the attached drawings. Components common in a plurality of drawings are assigned with the same reference signs throughout the plurality of drawings. It should be noted that each drawing is not necessarily drawn to an accurate scale for the convenience of description.

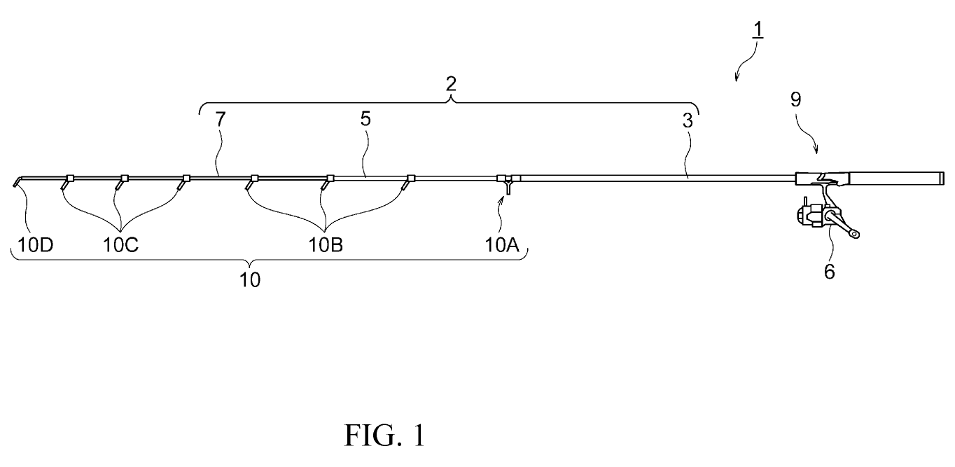

FIG. 1 is a view illustrating one embodiment of a fishing rod according to the present invention. As illustrated in the drawing, a fishing rod 1 according to one embodiment of the present invention comprises a rod body 2, a reel 6 attached to the rod body 2 via a reel seat 9, and a fishing line guide 10 attached to the rod body 2. In the illustrated embodiment, each of the reel seat 9 and the fishing line guide 10 corresponds to an attachment component attached to an outer peripheral surface of the rod body.

The rod body 2 is formed by, for example, connecting a base rod 3, a middle rod 5, a tip rod 7, and the like to each other. These rod bodies are jointed to each other, for example, as an ordinarily jointed type. The base rod 3, the middle rod 5, and the tip rod 7 can be joined to each other by a telescopic type, an inversely jointed type, a socket-and-spigot jointed type, or any other known joining method. The rod body 2 may be constituted by a single rod body.

Each of the base rod 3, the middle rod 5, and the tip rod 7 is formed by, for example, a tubular body made of a fiber-reinforced resin. This tubular body made of the fiber-reinforced resin is produced by winding a fiber-reinforced resin prepreg (prepreg sheet) obtained by impregnating reinforcing fibers with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. In addition, an outer surface of the tubular body is appropriately polished. Each of the rod bodies may be formed in a solid state.

In the illustrated embodiment, the base rod 3, the middle rod 5, and the tip rod 7 comprise a plurality of the fishing line guides 10 (fishing line guides 10A to 10D) for guiding a fishing line fed from the reel 6 attached to the reel seat 9. More specifically, the base rod 3 is provided with the fishing line guide 10A, the middle rod 5 is provided with the fishing line guide 10B, and the tip rod 7 is provided with the fishing line guide 10C. The tip rod 7 comprises a top guide 10D at a front end thereof, but details thereof are omitted.

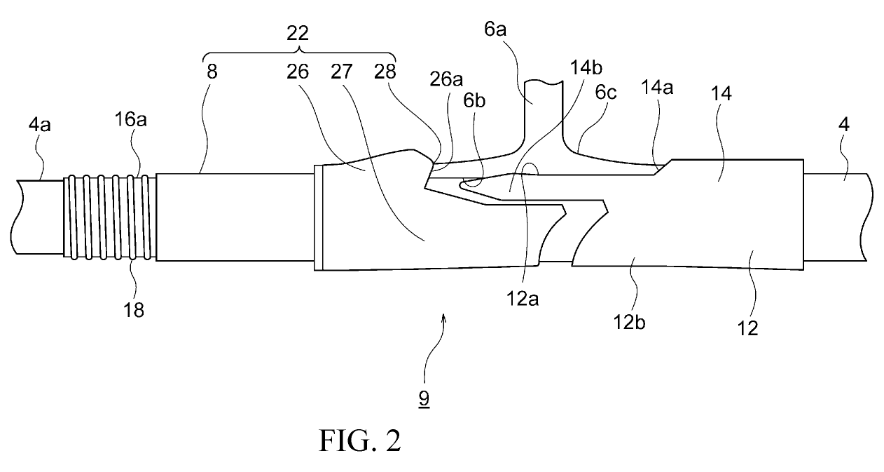

Next, a reel seat main body 12 and a fishing rod reel seat 9 comprising the reel seat main body will be described with reference to FIG. 2. The reel seat main body 12 comprises the reel seat main body 12 having, along its axial direction, a reel leg placing surface (reel leg placing portion) 12a on which a reel leg 6a of the reel 6 for fishing is placed. The reel seat main body 12 is formed in a cylindrical shape or a substantially cylindrical shape as a whole. In addition, the reel seat main body 12 is made of an appropriate material such as a synthetic resin (for example, polyamide-based synthetic fiber, ABS resin, or the like) or metal (for example, SUS, aluminum, titanium, brass, or the like). The reel seat main body 12 can be configured with, for example, a length of 60 to 160 mm, but is not limited thereto. In addition, the reel seat main body 12 may form a grip portion 12b that slightly bulges opposite to the reel leg placing surface 12a, and that has a curved outer surface which is made easy to grip by supporting the thenar or the vicinity thereof when gripped with a gripping hand.

The reel leg placing surface 12a of the reel seat main body 12 can be formed flat or substantially flat with a larger curvature than other circumferential portions (for example, the grip portion 12b) adjacent to the reel leg placing surface 12a of the reel seat main body 12, and is formed to extend in the axial direction of the reel seat main body 12 illustrated in FIG. 2. A fixed hood 14 is integrally disposed on one end (rod tip side) of the reel seat main body 12. A part of the reel leg placing surface 12a of the reel seat main body 12 is disposed inside the fixed hood 14.

The reel seat main body 12 is integrally provided with a cylindrical body in which a guide groove is formed at the other end (rod butt side) and a screw portion (male screw portion) 18. In the cylindrical body, a cylindrical portion placing surface 16a is formed continuously with the reel leg placing surface 12a of the reel seat main body 12 or with a slight step difference. In one embodiment of the present invention, a step difference for disposing a back surface holding portion of a reel leg holding portion 28 is formed between the reel leg placing surface (reel leg placing portion) 12a and the cylindrical portion placing surface 16a so that the back surface holding portion of the reel leg holding portion 28, which will be described later, on which a back surface (bottom surface) 6b of the reel leg 6a is placed and the reel leg placing surface 12a are as flush as possible. The cylindrical portion placing surface 16a is also formed continuously with the screw portion (male screw portion) 18. At the other end (rod butt side), a moving hood 22 (also referred to as a floating hood) is attached to the outside of the cylindrical body and the screw portion 18 so as to be movable in the axial direction. Here, the reel seat main body 12 and the moving hood 22, or the reel seat main body 12, the moving hood 22, and a nut 8 may be referred to as the fishing rod reel seat 9, but details are omitted.

As illustrated in FIG. 2, in the fixed hood 14 of the reel seat main body 12, an opening portion 14a that receives one end of the reel leg 6a is opened toward the moving hood 22. The opening portion 14a of the fixed hood 14 is formed such that the height of an inner surface is gradually decreased toward a front of the reel seat main body 12. When one end of the reel leg 6a is received in the opening portion 14a and the one end of the reel leg 6a is pressed by the opening portion 14a, the reel leg 6a is biased (pressed) toward the reel leg placing surface 12a disposed in the fixed hood 14.

Note that the fixed hood 14 is not limited to being disposed integrally with the reel seat main body 12, and may be formed of a metal or a hard synthetic resin to have a structure separate from the reel seat main body 12 and firmly fixed to the reel seat main body 12. In a case of being formed of metal, it is preferable to dispose a resin member at a portion abutting on the reel leg 6a of the reel 6 to prevent damage to each member due to the contact between metals.

The moving hood 22 is formed in a sleeve shape penetrating an axial hole through which the screw portion (male screw portion) 18 of the reel seat main body 12 is inserted, and comprises a hood portion (hood main body) 26, the reel leg holding portion 28 fixed to the inside of the hood portion (hood main body) 26, and a finger placement portion (extension portion) 27 to be described in detail later. The nut 8 is rotatably connected to a rear portion (rod butt side) of the hood portion (hood main body) 26 of the moving hood 22, and the finger placement portion (extension portion) 27, which will be described in detail later, is similarly formed in a front portion (rod tip side) of the hood portion (hood main body) 26. The nut 8 is formed of, for example, synthetic resin, metal, polyamide synthetic fiber, ABS resin, aluminum, brass, or the like, the hood portion (hood main body) 26 is formed of, for example, metal (SUS, brass) or the like, and the reel leg holding portion 28 is formed of, for example, polyamide-based synthetic fiber or the like.

In the nut 8, a female screw portion (not illustrated) screwed to the screw portion (male screw portion) 18 is formed on the inner peripheral side, and the outer peripheral side is formed to be less slippery and to be easily rotated. A front end of the nut 8 is connected (locked) to a rear end of the hood portion (hood main body) 26 in a state of being relatively rotatable and prevented from coming off. More specifically, the nut 8 comprises a locking portion (not illustrated), is locked by a locked portion (not illustrated) at the rear end of the hood portion (hood main body) 26, and can be configured to be prevented from coming off while being relatively rotatable. Note that the connection structure between the nut 8 and the hood portion (hood main body) 26 is variously considered, and is not limited to a specific aspect.

The nut 8 is screwed with the screw portion (male screw portion) 18 of the reel seat main body 12 and rotatably disposed. As described above, since the hood portion (hood main body) 26 is connected to the nut 8, when the nut 8 is rotated in the positive direction with respect to the screw portion (male screw portion) 18, the nut 8 approaches the fixed hood 14 and the hood portion (hood main body) 26 of the moving hood 22 approaches the fixed hood 14. On the other hand, when the nut 8 is rotated in a reverse direction with respect to the screw portion (male screw portion) 18, the nut 8 is moved away from the fixed hood 14 and the hood portion (hood main body) 26 of the moving hood 22 is moved away from the fixed hood 14.

The hood portion (hood main body) 26 moved in the axial direction of the reel seat main body 12 by the rotation of the nut 8 comprises an opening portion 26a that is opened on the front side and the inner peripheral side and is fixed in a state where the reel leg holding portion 28 for receiving the rear end of the reel leg 6a of the reel 6 for fishing is disposed. The opening portion 26a of the hood portion (hood main body) 26 faces the opening portion 14a of the fixed hood 14 when the moving hood 22 is attached to the screw portion (male screw portion) 18 of the reel seat main body 12. Contrary to the opening portion 14a of the fixed hood 14, the opening portion 26a of the hood portion (hood main body) 26 is formed such that the height of the inner surface is gradually decreased toward the rear.

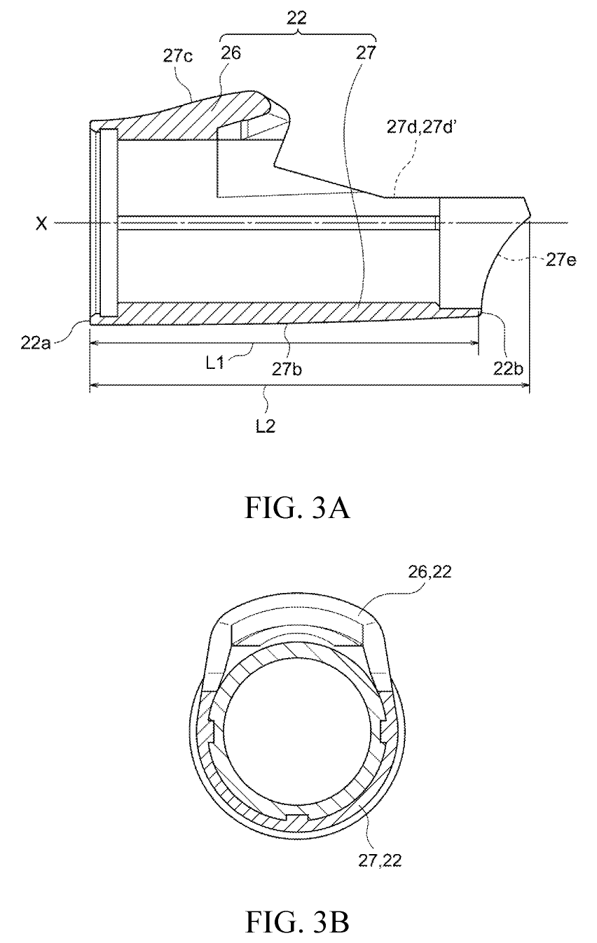

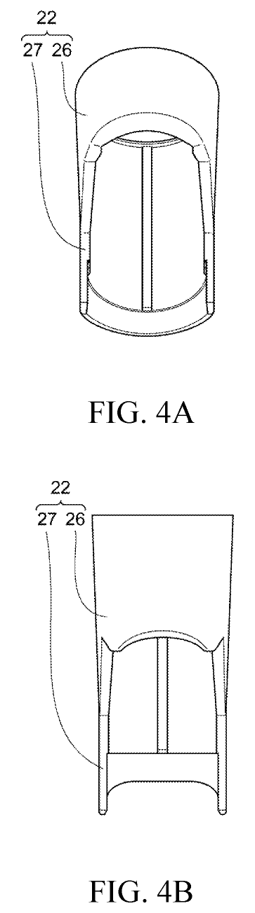

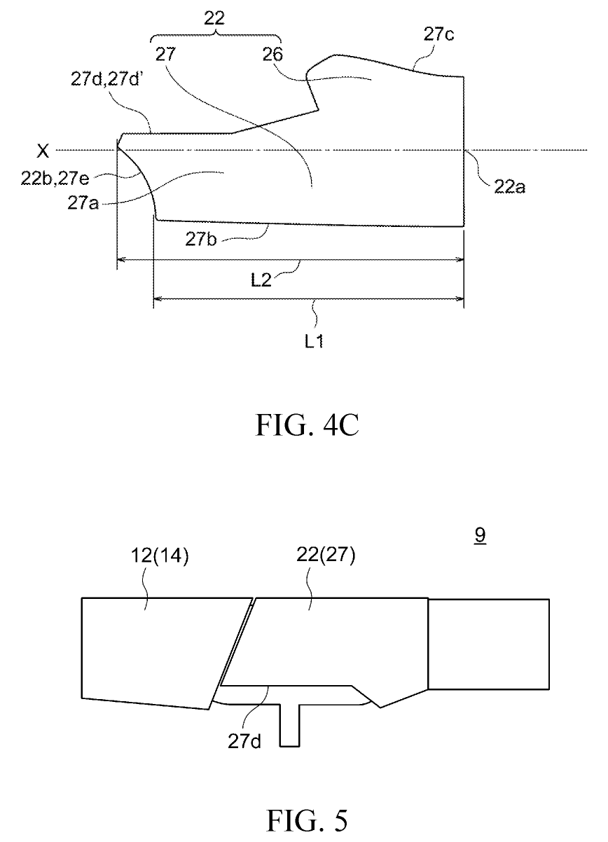

Next, the reel seat 9 according to one embodiment of the present invention will be further described in detail with reference to FIGS. 2, 3A to 3B and 4A to 4C. FIG. 3A is a configuration diagram including a partial cross-sectional view (a cross section in a direction from the center of the bottom surface toward the center of the upper surface of the reel seat main body) of the moving hood 22 of the reel seat 9 according to one embodiment of the present invention, and FIG. 3B is a configuration diagram including a cross-sectional view (a cross section perpendicular to the central axis of the reel seat main body) of the moving hood 22 of the reel seat 9 according to one embodiment of the present invention. FIG. 4A is a top perspective view of the reel seat 9 according to one embodiment of the present invention, FIG. 4B is a top view of the reel seat 9 according to one embodiment of the present invention, and FIG. 4C is a side view of the reel seat 9 according to one embodiment of the present invention.

As illustrated in FIGS. 2, 3A to 3B and 4A to 4C, the fishing rod reel seat 9 according to one embodiment of the present invention comprises the reel seat main body 12 in which the reel leg placing portion 12a on which the reel leg 6a is placed and the fixed hood 14 into which one end of the reel leg 6a is inserted are formed, and a moving hood 22 that is guided to an outer surface of the reel seat main body 12 and is configured to be movable along an axial direction of the reel seat main body 12, and the moving hood 22 comprises the hood portion 26 into which the other end of the reel leg 6a is inserted, and the finger placement portion 27 (also referred to as an extension portion, but hereinafter referred to as a finger placement portion) extending from a first end 22a to a second end 22b of the moving hood 22 as viewed in the axial direction of the reel seat main body 12, a maximum length (L2) in the axial direction of the reel seat main body from the first end 22a to the second end 22b at a position (a side surface of the finger placement portion 27 as viewed in the direction of FIG. 4C) of the side surface portion 27a of the finger placement portion 27 as viewed in the circumferential direction of the reel seat main body is larger than a length (L1) in the axial direction of the reel seat main body 12 from the first end 22a to the second end 22b at a position of a bottom surface portion 27b (bottom surface portion 27b illustrated in FIGS. 3A and 4C) of the finger placement portion 27 as viewed in the circumferential direction of the reel seat main body 12.

According to the fishing rod reel seat 9 according to one embodiment of the present invention, it is possible to provide the fishing rod reel seat in which the gripping fingertip is prevented from coming into contact with the step difference between the moving hood and the reel seat main body and the gripping properties are improved when the reel seat is gripped.

In addition, in the fishing rod reel seat 9 according to one embodiment of the present invention, a first edge portion 27d formed at the end of the finger placement portion 27 as viewed in the circumferential direction (circumferential direction of FIG. 3B and vertical direction of a paper surface of FIG. 4C) of the reel seat main body 12 is formed on the upper surface portion 27c side opposite to the bottom surface portion 27b with the axial direction of the reel seat main body 12 as a reference line (X) as viewed in the direction from the bottom surface portion 27b to the upper surface portion 27c of the finger placement portion 27 as viewed in the circumferential direction (circumferential direction of FIG. 3B and vertical direction of a paper surface of FIG. 4C) of the reel seat main body 12. In this manner, by further increasing the surface area of the finger placement portion 27, it is possible to prevent the gripping fingertip from coming into contact with the step difference between the moving hood and the reel seat main body, and thus it is possible to provide the fishing rod reel seat having improved gripping properties when the reel seat is gripped. Note that, in a case where the moving hood 22 moves to the fixed hood 14, the first edge portion 27d is configured to abut on an abutment portion 14b formed on the fixed hood side. In this manner, the abutment portion 14b and the finger placement portion 27 are nearly flush with each other while unnecessary backlash of the moving hood with respect to the reel seat main body 12 is suppressed, so that the region for placing the finger can be further increased.

Here, in the fishing rod reel seat 9 according to one embodiment of the present invention, a part of the first edge portion 27d formed at the end of the finger placement portion 27 as viewed in the circumferential direction (circumferential direction of FIG. 3B and vertical direction of a paper surface of FIG. 4C) of the reel seat main body 12 has a parallel portion 27d’ parallel to the axial direction of the reel seat main body 12. In this manner, unnecessary backlash of the moving hood 22 with respect to the reel seat main body 12 can be effectively suppressed. In addition, the length of the parallel portion 27d’ (the length in the axial direction of the reel seat main body 12) is preferably in a range of 10 mm or more to 20 mm or less. As a result, in view of the fact that the ball of the middle finger is about 15 mm on average, it is possible to avoid unnecessary weight increase due to formation of the parallel portion 27d’ longer than necessary where the ball of the middle finger is likely to be placed. In addition, the parallel portion 27d’ of the first edge portion 27d formed at the end of the finger placement portion 27 as viewed in the circumferential direction (circumferential direction of FIG. 3B and vertical direction of a paper surface of FIG. 4C) of the reel seat main body 12 is formed on the upper surface portion 27c side opposite to the bottom surface portion 27b in a range of 0 to 5 mm from the reference line (X) in the axial direction of the reel seat main body 12 as viewed in the direction from the bottom surface portion 27b to the upper surface portion 27c of the finger placement portion 27 as viewed in the circumferential direction (circumferential direction of FIG. 3B and vertical direction of a paper surface of FIG. 4C) of the reel seat main body 12. In this manner, it is possible to secure the thickness of the abutment portion 14b formed in the fixed hood 14.

In addition, in the fishing rod reel seat 9 according to one embodiment of the present invention, the maximum length (L2) in the axial direction of the reel seat main body 12 from the first end 22a to the second end 22b at a position (the side surface of the finger placement portion 27 as viewed in the direction of FIG. 4C) of the side surface portion 27a of the finger placement portion 27 as viewed in the circumferential direction of the reel seat main body 12 is larger by 5 mm or more than the length (L1) in the axial direction of the reel seat main body 12 from the first end 22a to the second end 22b at a position of the bottom surface portion 27b (bottom surface portion 27b illustrated in FIGS. 3A and 4C) of the finger placement portion 27 as viewed in the circumferential direction of the reel seat main body 12. In this manner, by further increasing the surface area of the side surface portion of the finger placement portion, it is possible to prevent the gripping fingertip from coming into contact with the step difference between the moving hood and the reel seat main body, and thus it is possible to provide the fishing rod reel seat having improved gripping properties when the reel seat is gripped.

In addition, in the fishing rod reel seat 9 according to one embodiment of the present invention, the length (L1) in the axial direction of the reel seat main body 12 from the first end 22a to the second end 22b at a position of the bottom portion 27b (bottom surface portion 27b illustrated in FIGS. 3A and 4C) of the finger placement portion 27 as viewed in the circumferential direction of the reel seat main body 12 is larger than a maximum length of the hood portion in the axial direction of the reel seat main body. In this manner, by providing a wider region for placing the finger so as to extend continuously from the hood portion, it is possible to prevent the gripping fingertip from coming into contact with the step difference between the moving hood and the reel seat main body, and thus it is possible to provide the fishing rod reel seat having improved gripping properties when the reel seat is gripped.

In addition, in the fishing rod reel seat 9 according to one embodiment of the present invention, a second edge portion 27e formed at the second end 22b of the finger placement portion 27 as viewed in the axial direction of the reel seat main body 12 extends from the bottom surface portion 27b of the finger placement portion 27 as viewed in the circumferential direction of the reel seat main body 12 to the first edge portion 27d in the direction of the side surface portion 27a as viewed in the circumferential direction of the reel seat main body 12, and as illustrated in FIGS. 4A and 4B, the second edge portion 27e is formed in a concave shape in the direction of the second end 22b from the first edge portion 27d toward the bottom surface portion 27b. In this manner, it is possible to easily secure the surface on which the thumb (first finger) is placed when the reel seat main body 12 (fixed hood 14) is gripped. Here, the end surface of the second edge portion 27e may be formed to have a chamfered (curved) shape. When the end surface of the moving hood 22 has an acute angle end, cracking is likely to occur, but by forming in this manner, cracking of the end surface of the moving hood can be effectively suppressed.

The fishing rod 1 according to one embodiment of the present invention comprises the fishing rod reel seat 9 according to one embodiment of the present invention and the rod body 2. Here, the fishing rod reel seat 9 according to one embodiment of the present invention can be applied to a fishing rod for an up-lock type (a type of tightening toward a rod tip) spinning reel.

According to the fishing rod 1 according to one embodiment of the present invention, it is possible to provide the fishing rod comprising the fishing rod reel seat in which the gripping fingertip is prevented from coming into contact with the step difference between the moving hood and the reel seat main body and the gripping properties are improved when the reel seat is gripped.

Next, the fishing rod reel seat 9 according to another embodiment of the present invention will be described with reference to FIGS. 5 to 7.

First, as illustrated in FIG. 5, in fishing rod reel seat 9 according to another embodiment of the present invention, a basic aspect is similar to that of the fishing rod reel seat 9 according to one embodiment of the present invention described above, and thus the description thereof is omitted, but there is no abutment portion 14b (for example, the aspect illustrated in FIG. 2) formed on the fixed hood side on which the first edge portion 27d abuts when the moving hood 22 moves to the fixed hood 14. As a result, although the effect of suppressing unnecessary backlash of the moving hood 22 with respect to the reel seat main body 12 is reduced as compared with the aspect of the fishing rod reel seat 9 according to one embodiment of the present invention described above, it is possible to reduce deterioration of gripping properties caused by contact of a human finger or fingertip with a step difference between the moving hood 22 and the reel seat main body 12.

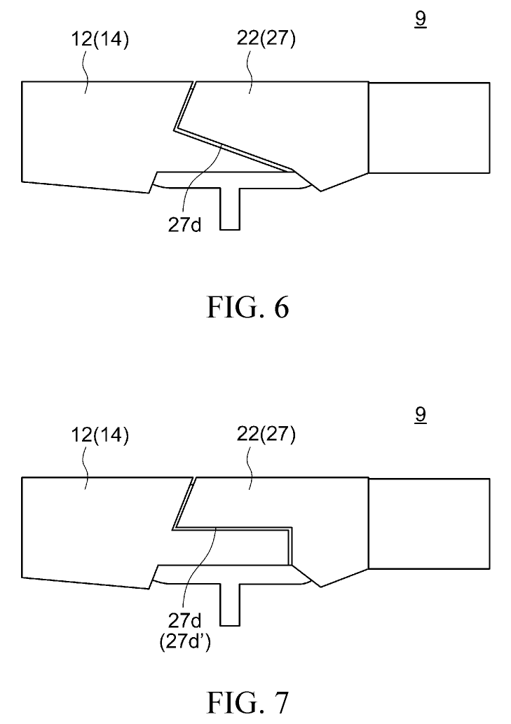

Next, as illustrated in FIG. 6, in the fishing rod reel seat 9 according to another embodiment of the present invention, a basic aspect is similar to that of the fishing rod reel seat 9 according to one embodiment of the present invention described above, and thus the description thereof is omitted, but there is no parallel portion 27d’ (for example, the aspect illustrated in FIG. 4C) parallel to the axial direction of the reel seat main body 12, of a part of the first edge portion 27d formed at the end of the finger placement portion 27 as viewed in the circumferential direction (circumferential direction of FIG. 3B and vertical direction of paper surface of FIG. 4C) of the reel seat main body 12. As a result, as compared with the aspect of the fishing rod reel seat 9 according to one embodiment of the present invention described above, since the first edge portion 27d does not have the parallel portion 27d’, the effect of suppressing unnecessary backlash of the moving hood 22 with respect to the reel seat main body 12 is reduced, but it is possible to reduce deterioration of gripping properties caused by contact of a human finger or fingertip with a step difference between the moving hood 22 and the reel seat main body 12.

Next, as illustrated in FIG. 7, in the fishing rod reel seat 9 according to another embodiment of the present invention, a basic aspect is similar to that of the fishing rod reel seat 9 according to one embodiment of the present invention described above, and thus the description thereof is omitted, but the parallel portion 27d’ parallel to the axial direction of the reel seat main body 12 is formed on the entire first edge portion 27d formed at the end of the finger placement portion 27 as viewed in the circumferential direction (circumferential direction of FIG. 3B and vertical direction of paper surface of FIG. 4C) of the reel seat main body 12. As a result, as compared with the aspect of the fishing rod reel seat 9 according to one embodiment of the present invention described above, since the parallel portion 27d’ exists over the entire first edge portion 27d, a possibility that a human finger or a fingertip comes into contact with a step difference between the moving hood 22 and the reel seat main body 12 to deteriorate gripping properties is increased, but it is possible to suppress unnecessary backlash of the moving hood 22 with respect to the reel seat main body 12.

The dimension, material, and disposition of each component described in the present specification are not limited to those explicitly described in the embodiments, and each component can be modified to have any dimension, material, and disposition that are within the scope of the present invention. In addition, components not explicitly described in the present specification can also be added to the described embodiments, or some of the components described in the embodiments can be omitted.

### REFERENCE SIGNS LIST

1 Fishing rod

2 Rod body

3 Base rod

5 Middle rod

6 Reel

6a Reel leg

7 Tip rod

8 Nut

9 Fishing rod reel seat

10 Fishing line guide

12 Reel seat main body

12a Reel leg placing surface

14 Fixed hood

14a Opening portion

14b Abutment portion

16a Cylindrical portion placing surface

18 Screw portion (male screw portion)

22 Moving hood

22a First end

22b Second end

26 Hood portion (hood main body)

27 Finger placement portion (extension portion)

27a Side surface portion

27b Bottom surface portion

27c Upper surface portion

27d First edge portion

27d' Parallel portion

27e Second edge portion

28 Reel leg holding portion

What is claimed is:

1. A fishing rod reel seat comprising: a reel seat main body in which a reel leg placing portion on which a reel leg is placed and a fixed hood into which one end of the reel leg is inserted are formed; and a moving hood guided to an outer surface of the reel seat main body and configured to be movable along an axial direction of the reel seat main body,
wherein the moving hood comprises: a hood portion into which the other end of the reel leg is inserted; and a finger placement portion extending from a first end to a second end of the moving hood as viewed in the axial direction of the reel seat main body, and
a maximum length (L2) of the finger placement portion in the axial direction of the reel seat main body from the first end to the second end at a position of a side surface portion of the finger placement portion as viewed in a circumferential direction of the reel seat main body is larger than a length (L1) of the finger placement portion in the axial direction of the reel seat main body from the first end to the second end at a position of a bottom surface portion of the finger placement portion as viewed in the circumferential direction of the reel seat main body.

2. The fishing rod reel seat according to claim 1, wherein a first edge portion formed at an end of the finger placement portion as viewed in the circumferential direction of the reel seat main body is formed on an upper surface portion side opposite to the bottom surface portion with the axial direction of the reel seat main body as a reference line as viewed in a direction from the bottom surface portion to an upper surface portion of the finger placement portion as viewed in the circumferential direction of the reel seat main body.

3. The fishing rod reel seat according to claim 1, wherein a maximum length (L2) of the finger placement portion in the axial direction of the reel seat main body from the first end to the second end at a position of a side surface portion of the finger placement portion as viewed in the circumferential direction of the reel seat main body is larger by 5 mm or more than a length (L1) of the finger placement portion in the axial direction of the reel seat main body from the first end to the second end at a position of the bottom surface portion of the finger placement portion as viewed in the circumferential direction of the reel seat main body.

4. The fishing rod reel seat according to claim 1, wherein the length (L1) of the finger placement portion in the axial direction of the reel seat main body from the first end to the second end at a position of the bottom surface portion of the finger placement portion as viewed in the circumferential direction of the reel seat main body is larger than a maximum length of the hood portion in the axial direction of the reel seat main body.

5. The fishing rod reel seat according to claim 1, wherein a second edge portion formed at the second end of the finger placement portion as viewed in the axial direction of the reel seat main body extends from the bottom surface portion of the finger placement portion as viewed in the circumferential direction of the reel seat main body to the first edge portion in a direction of a side surface portion of the finger placement portion as viewed in the circumferential direction of the reel seat main body, and
the second edge portion is formed in a concave shape in a direction of the second end from the first edge portion toward the bottom surface portion.

6. A fishing rod comprising: the fishing rod reel seat according to claim 1; and a rod body.
